(19) United States
(12) Patent Application Publication
(10) Pub. No.: US 2003/0094589 A1
(43) Pub. Date: May 22, 2003

(54) Supply tank cover assembly

(76) Inventors: George LeMoine, Trumbull, CT (US); Donald Barker, Sandy Hook, CT (US); Roger Lay, Woodbury, CT (US); Jill E. Lay, Woodbury, CT (US)

Correspondence Address: PERMAN & GREEN, 425 POST ROAD, FAIRFIELD, CT, 06824, US

(21) Appl. No.: 10/126,391

(22) Filed: Apr. 19, 2002

Related U.S. Application Data
(60) Provisional application No. 60/332,083, filed on Nov. 21, 2001.

(51) Int. Cl. F16K 51/00

(52) U.S. Cl. 251/149.6

(57) ABSTRACT

An improved supply tank opening cover assembly facilitates excellent fluid transfer between a supply tank and a reservoir, while minimizing leaks. Useful in machines that produce or affix labels, such as franking machines, the preferred embodiment of the assembly includes: an outer cap with an aperture for fluid transfer therethrough; an elastomeric flap placed in the outer cap; a spring member that impinges at one end on the flap, and impinges at the other end on a portion of a support cage; and an inner gasket. With the aid of the spring member, the flap is biased to normally cover the aperture and prevent leakage of the fluid. To allow the transfer of fluid from the supply tank to a reservoir, a reservoir peg is inserted into the aperture and displaces the flap from its sealed position. Liquid transfer from the supply tank to the reservoir is aided by the transposition of air from outside the tank to replace vacated supply tank liquid.

### CROSS-REFERENCE TO RELATED APPLICATIONS

This application claims priority from Provisional Application No. 60/332,083, filed Nov. 21, 2001, which is incorporated by reference in its entirety.

### BACKGROUND OF THE INVENTION

1. Field of the Invention

The present invention generally relates to supply tank and bottle dispenser caps and valves used to permit the transfer of a stored fluid on the one hand, while minimizing fluid leakage on the other hand. Among the numerous applications are mechanisms for transferring water to labels with dry adhesives in apparatuses such as franking machines.

2. Prior Art

Many machines have a need to dispense water and other fluids efficiently and without leakage on unintended portions of the machine. There are several prior art general configurations for tank and dispenser caps which all have drawbacks.

One approach uses a stretchable membrane in the middle of the cap. While often providing an excellent seal, stretchable membranes are not durable enough for repeated use, leading to tears and cracks. Additionally, many stretchable seals do not allow “air bleeding” to facilitate the transfer of liquids from the supply tank, requiring suction and pumping as the primary or exclusive means for moving the liquid from the supply tank.

Another approach includes a rigidly, or semi-rigidly lined feeder hole of a fixed dimension in the cap, that is pressed tightly against the reservoir protrusion. Using this approach, leaking may occur because eccentricities in either the feeder hole or the protrusion may leave undesirable openings therebetween. Paradoxically, when there is a tight seal, there is no “air bleeding” to facilitate liquid transfer, requiring suction or other means to make this approach practical.

What is therefore needed in the environment described above but not taught or suggested by the prior art, is an assembly for easily transferring fluid from a supply tank to a reservoir, that is durable, does not require suction or pumping for fluid transfer, and. provides an excellent seal to prevent fluid leakage when fluid transfer is not intended.

### SUMMARY OF THE INVENTION

In view of the above-identified problems and limitations of the prior art, the present invention provides a tank opening cover assembly adapted to function as a valve for a fluid supply tank. The assembly at least includes an outer cap having a fluid transfer aperture, the inner wall of the outer cap adapted to engage with the open end of the tank, an elastomeric flap adapted to be placed between the outer cap and the open end of the tank, a spring member support coupled between the flap and the open end of the tank, and a spring member adapted to be coupled at one end to the flap, and adapted to be coupled at another end to the spring member support. The spring member support is adapted to hold the spring member in place, the spring member being adapted to bias the flap in a position of sealably covering the aperture. The tank opening cover assembly is adapted to provide a seal between the edges of the open end of the tank and the outer cap, and the tank opening cover assembly is adapted to allow fluid transfer when an external member enters the aperture and displaces the flap away from the aperture.

The present invention is described in detail below, with reference to the drawings.

### BRIEF DESCRIPTION OF THE DRAWINGS

Features and advantages of the present invention will become apparent to those skilled in the art from the following description with reference to the drawings, in which:

FIG. 1 is an exploded view of the present-inventive supply tank opening cover assembly;

FIG. 2 is a cross-sectional side view of the present-inventive supply tank opening cover assembly engaged with the supply tank, and having a closed flap; and

FIG. 3 is a cross-sectional side view of the present-inventive supply tank opening cover assembly engaged with the supply tank, and having an open flap as a result of having a reservoir peg inserted in the assembly.

### DETAILED DESCRIPTION OF THE PREFERRED EMBODIMENTS

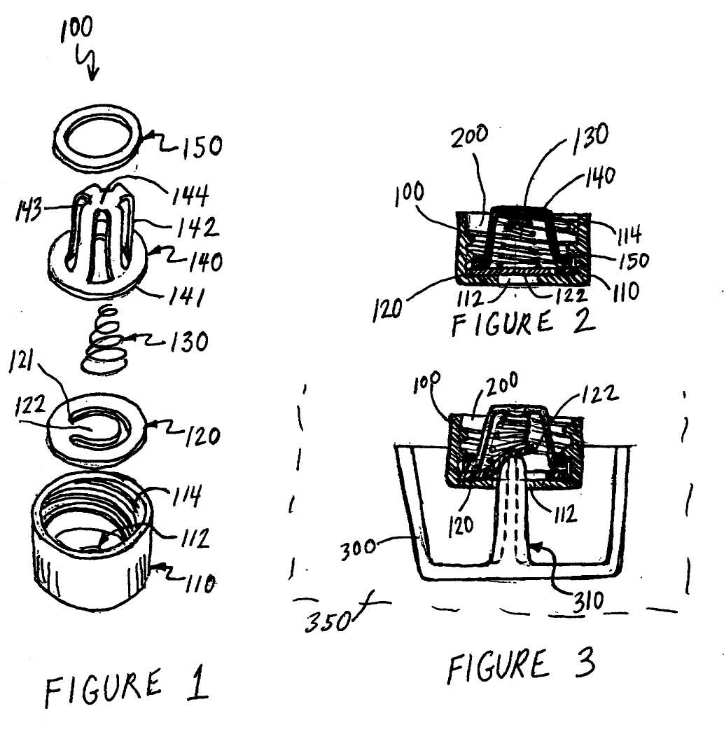

The present-inventive supply tank cover assembly 100 is illustrated via an exploded view in FIG. 1, and the cross-section views in FIGS. 2 and 3. FIG. 2 shows the assembly 100 engaged with a supply bottle or supply tank 200, and in the closed or sealed position. FIG. 3 shows the assembly 100 and the supply tank 200 engaged with a peg or protrusion 310 of a reservoir 300, with the assembly in the open or unsealed position. The reservoir 300 may be part of a larger apparatus such as a franking machine or a tape dispenser or shipping tape dispenser generically represented by the number 350.

The supply tank cover assembly 100 has a threaded outer cap 110 with threads 114 matching the threads at the end of the supply tank 200. In the embodiment shown in FIG. 1, the supply tank cover assembly is fitted to the supply tank by relative rotation between the two parts in a screw-like fashion. However, other attachment schemes are possible without departing from the scope of the present invention. The outer cap 110 can be made of any suitable material, including, inter alia, plastic and metal (such as aluminum, brass, steel, etc.). Further, while the threads 114 are internal in the example, it is possible to place them external to the cap, in which case the matching threads of the supply tank would be internal to the supply tank opening.

The outer cap 110 contains a fluid transfer aperture 112 for allowing liquids to pass from the supply tank 200 to the reservoir 300, and for allowing air to fill in for the displaced liquid void in the supply tank to facilitate liquid transfer. While the aperture 112 is circular in the example of drawing figures, many other shapes (e.g., elliptical, polygonal) are possible. In fact, the “aperture” need not be limited to a single hole or void, but may include a plurality of patterned or unpatterned holes.

A flap member 120 is placed in the outer cap, and has a formed elastic flap 122. During manufacture, the flap member 120 can simply be molded with spacing between the flap 122 and the rest of the flap member 120 as shown. Alternatively, the shape of the flap 122 can be later cut automatically or manually. The flap member and flap are constructed with a compliant elastomer, such as rubber, silicone, or thermoplastic. This provides good flexibility and durability in the flap. The outer portion of the flap member acts as an outer ring to provide a seal between the outer cap and a spring member support 140, described infra.

The flap 122 is normally held in place over the aperture 112 to seal it from fluid leakage, by the action of a tapered spring member 130 pushing against a support cage or spring member support 140. The ledges 141 of the spring member support 140 are held in place against the outer ring of the flap member 120 by the pressure of the outer cap 110 exerted on the lip of the supply tank 200. In the embodiment of FIG. 1, the ledges 141 are formed by a continuous member, although the ledges may be sectioned in an alternate embodiment. The spring member support 140 has a seat 144 for receiving the spring member 130 at a balanced point. The spring member support 140 also has support members 142 that connect the spring seat 144 with ledges 141. The support members 142 are distributed equally around the perimeter of the spring member support 140, and are separated by gaps 143 that allow fluid transfer through the spring member support. As seen best in FIG. 2, the support members 142 taper inward between the seat 144 and ledges 141, giving support 140 a generally tapered shape. The taper of the support members 142, however, is such that it allows unencumbered compression of the spring member 130 supported inside the spring member support 140.

Also included is a gasket or O-ring 150 that provides the primary seal between the cover assembly 100 and the supply tank 200. Those skilled in the art will appreciate that the gasket can be permanently affixed to the spring member support, or that the material of the spring member support can have sufficient elasticity to serve as a seal.

The flap 122 is sized to sufficiently cover the aperture 112, but not be pushed into or through the aperture by the force of the spring member 130 or fluid pressure. It is also possible to reinforce the flap 122 with a more rigid sheet member covered by the elastomeric material to better withstand the force of the spring member 130.

While shown as a traditional spring, the spring member 130 can also take other forms that serve the same function. In the embodiment disclosed, the spring member 130 is a helical spring wire wound in sequentially smaller diameters from the bottom end resting against the flap 122 to the opposite end, to give the spring member a tapered shape. The bottom end is sized to fit within the projected area of the flap.

FIG. 2 illustrates the normally closed position of the flap 122 to prevent or minimize fluid from leaking when the supply tank is not engaged with the reservoir 300. When the supply tank (where the cover assembly on the supply tank is oriented downward) is lowered onto a reservoir protrusion or peg 310, as shown in FIG. 3, the flap 122 is displaced inward. A connection section 121 acts as a hinge to allow the flap 122 to pivot inside of the spring member support 140. This uncovers or opens the aperture 112, thereby allowing fluid transfer between the supply tank and the reservoir. In this way, the action of the flap 122 is analogous to a valve. Prior to placement of the supply tank over the reservoir protrusion with the cover assembly oriented down, the weight of the liquid upon the flap also aids, along with the bias from the spring member 130, in maintaining a good seal until the flap is actually displaced by the protrusion 310 to prevent spillage of the liquid while it is in the supply tank. While not shown, the reservoir 300 may include a ledge or other support member to limit the downward movement of the cover assembly and supply to prevent damage to the seat 144 from the protrusion 310.

The protrusion 310 is sized to have a smaller girth than the aperture 112. When the flap 122 is displaced by the protrusion 310, the liquid exits the bottle into the reservoir 300. Meanwhile, air from outside of the supply tank travels into the supply tank to occupy the space vacated by the exiting liquid. The transfer of fluids continues until a state of equilibrium is reached. That is, the liquid level in the reservoir rises to meet the aperture and cut off the flow of air into the supply tank, thereby stopping the discharge of fluid out of the supply tank. As the level of fluid in the reservoir is reduced through use, additional fluid is automatically discharged through the “valve” from the supply tank to replenish the reservoir fluid.

The tapered, helical shape of the spring member 130 has additional function, including greater ease of movement of the flap, and larger displacement, as compared to non-tapered springs. The relative ease of displacement further prevents the protrusion from spearing through the flap. Also, the larger openings between the tapered spring allow greater fluid flow therethrough.

The disclosed supply tank cover assembly closes the flap 122 automatically against the seat of the aperture 112 to prevent fluid spillage when the cover assembly and supply tank are removed from the reservoir 300, and when they are turned upright.

Variations and modifications of the present invention are possible, given the above description. However, all variations and modifications which are obvious to those skilled in the art to which the present invention pertains are considered to be within the scope of the protection granted by this Letters Patent.

For example, while the operation of the cover assembly is explained assuming water as the stored liquid, any fluid that is not highly viscous can be handled by the cover assembly.

What is claimed is:

1. A tank opening cover assembly adapted to function as a valve for a fluid supply tank, said assembly comprising:
an outer cap having a fluid transfer aperture, the inner wall of said outer cap adapted to engage with the open end of said tank;
an elastomeric flap adapted to be placed between said outer cap and the open end of said tank;
a spring member support coupled between said flap and the open end of said tank; and
a spring member adapted to be coupled at one end to said flap, and adapted to be coupled at another end to said spring member support;
wherein said spring member support is adapted to hold said spring member in place, said spring member is adapted to bias said flap in a position of sealably covering said aperture, wherein said tank opening cover assembly is adapted to provide a seal between the edges of the open end of said tank and said outer cap, and wherein said tank opening cover assembly is adapted to allow fluid transfer when an external member enters said aperture and displaces said flap away from said aperture.

2. The tank opening cover assembly of claim 1, wherein said external member is coupled to a reservoir for receiving fluid from said tank.

3. The tank opening cover assembly of claim 1, wherein said fluid is a liquid, and wherein transfer of liquid from said tank is aided by the transposition of air external to said tank with liquid leaving said tank.

4. The tank opening cover assembly of claim 1, wherein said external member is coupled to a reservoir for receiving fluid from said tank, wherein said fluid is a liquid, wherein transfer of liquid from said tank is aided by the transposition of air external to said tank with liquid leaving said tank, and wherein liquid transfer from said tank and air transposition stop when an equilibrium level between said tank and said reservoir are reached.

5. The tank opening cover assembly of claim 1, wherein said spring member support is a cage allowing fluid transfer through its structural members.

6. The tank opening cover assembly of claim 1, wherein said outer cap inner walls are threaded, and the open end of said tank is threaded to match the threads of said outer cap.

7. The tank opening cover assembly of claim 1, further comprising:
a gasket adapted to be coupled between said spring member support and the open end of said tank and provide a seal between said tank and said tank opening cover assembly.

8. The tank opening cover assembly of claim 1, wherein said spring member has a tapered configuration along its substantial axis of symmetry.

9. The tank opening cover assembly of claim 1, wherein said tank is refilled with fluid by disengaging said outer cap from said tank to expose the open end of said tank.

10. The tank opening cover assembly of claim 1, wherein said reservoir is subsumed by an adhesive label facilitating apparatus.

11. The tank opening cover assembly of claim 10, wherein said apparatus is subsumed by a franking machine, or a shipping tape dispenser.

12. The tank opening cover assembly of claim 10, wherein said apparatus is subsumed by a franking machine, and the adhesive labels are mailing labels.

13. The tank opening cover assembly of claim 1, wherein said flap comprises:
an outer annular member; and
an inner pivot member coupled to said outer annular member, said inner pivot member carrying out the functions of said flap.

14. The tank opening cover assembly of claim 13, wherein said outer annular member and said inner pivot member are constructed as one piece.

15. A tank opening cover assembly for controlling the discharge from a fluid supply tank, said assembly comprising:
a cap adapted to cover an opening of said tank and having a fluid transfer aperture;
a flap adapted to be placed between said cap and the opening; and
a spring member adapted to be coupled between said cap and said flap;
wherein said spring member support is adapted to bias said flap in a position of sealably covering said aperture and closing the opening of said tank.

16. The tank opening cover assembly of claim 1, wherein the flap is moved from the position closing said tank to an open position when an external member is inserted through the opening of said tank.
